(19) United States
(12) Patent Application Publication
(10) Pub. No.: US 2025/0333592 A1
(43) Pub. Date: Oct. 30, 2025

(54) RESIN COMPOSITION

(71) Applicant: NAN YA PLASTICS CORPORATION, Taipei City (TW)

(72) Inventors: Ching-Yao Yuan, Taipei City (TW); Li Yun Chen, Taipei City (TW); Wei-Ru Huang, Taipei City (TW); Hung-Yi Chang, Taipei City (TW); Chia-Lin Liu, Taipei City (TW)

(73) Assignee: NAN YA PLASTICS CORPORATION, Taipei City (TW)

(21) Appl. No.: 18/666,773

(22) Filed: May 16, 2024

(30) Foreign Application Priority Data
Apr. 25, 2024 (TW) 113115424

(51) Int. Cl. C08L 63/00; C08K 3/013; C08K 5/10

(52) U.S. Cl. CPC C08L 63/00; C08K 3/013; C08K 5/10; C08K 2201/005; C08L 2205/025

(57) ABSTRACT

A resin composition includes an epoxy resin, an active ester compound, an acrylate resin, an inorganic filler material, and accelerator. The inorganic filler material includes a first filler and a second filler. The first filler has a first particle size. The second filler has a second particle size. The first particle size is greater than the second particle size, the second particle size is less than 100 nanometers, and a weight proportion of the second filler in the resin composition is between 1 wt % and 10 wt %.

### CROSS-REFERENCE TO RELATED APPLICATION

This application claims the priority benefit of Taiwan application serial no. 113115424, filed on Apr. 25, 2024. The entirety of the above-mentioned patent application is hereby incorporated by reference herein and made a part of specification.

### BACKGROUND

### Technical Field

The disclosure relates to a resin composition.

### Description of Related Art

In recent years, with the rapid development of integrated circuit (IC) technology, requirements such as wiring density (L/S) and transmission rate of chips (for example, high-speed computing chips) have increased. However, there is often an issue of poor copper-clad adhesion in the conventional low-roughness resin composition, which is not conducive to the application of high-frequency fast transmission.

### SUMMARY

The disclosure provides a resin product, which has preferable performance in terms of both copper-clad adhesion and roughness.

A resin composition of the disclosure includes an epoxy resin, an active ester compound, an acrylate resin, an inorganic filler material, and an accelerator. The inorganic filler material includes a first filler and a second filler. The first filler has a first particle size. The second filler has a second particle size. The first particle size is greater than the second particle size, the second particle size is less than 100 nanometers, and a weight proportion of the second filler in the resin composition is between 1 wt % and 10 wt %.

In an embodiment of the disclosure, the second particle size is greater than or equal to 0.01 micrometers.

In an embodiment of the disclosure, the first particle size is between 0.1 micrometers and 0.6 micrometers.

In an embodiment of the disclosure, a weight proportion of the first filler in the resin composition is between 60 wt % and 75 wt %.

In an embodiment of the disclosure, a weight proportion of the epoxy resin in the resin composition is between 5 wt % and 15 wt %, a weight proportion of the active ester compound in the resin composition is between 10 wt % and 20 wt %, a weight proportion of the inorganic filler material in the resin composition is greater than 60 wt %, a weight proportion of the acrylate resin in the resin composition is between 1 wt % and 15 wt %, and a weight proportion of the accelerator in the resin composition is between 0.1 wt % and 0.5 wt %.

In an embodiment of the disclosure, the epoxy resin includes a naphthalene ring epoxy resin, a bisphenol A type epoxy resin, or a combination thereof, the active ester compound includes a polyester resin, the acrylate resin includes a methacrylate polyphenylene ether resin, the inorganic filler material includes spherical silica, and the accelerator includes 4-dimethylaminopyridine.

In an embodiment of the disclosure, a usage amount of the first filler in the resin composition is greater than a usage amount of the second filler in the resin composition.

In an embodiment of the disclosure, a usage amount of the inorganic filler material in the resin composition is greater than a usage amount of the epoxy resin, the active ester compound, the acrylate resin, and the accelerator in the resin composition.

In an embodiment of the disclosure, a usage amount of the active ester compound in the resin composition is greater than a usage amount of the epoxy resin in the resin composition.

In an embodiment of the disclosure, a usage amount of the acrylate resin in the resin composition is greater than a usage amount of the accelerator in the resin composition.

Based on the above, in the disclosure, the filler with the small particle size is introduced to effectively reduce the roughness of subsequent processes. At the same time, through matching the two fillers with different particle sizes with each other, the addition proportion of the filler with the small particle size is controlled to be within the appropriate addition proportion range, so as to maintain the adhesion between the overall inorganic filler material and copper. In this way, the resin composition of the disclosure has preferable performance in terms of both copper-clad adhesion and roughness.

In order for the features and advantages of the disclosure to be more comprehensible, the following specific embodiments are described in detail in conjunction with the drawings.

### DESCRIPTION OF THE EMBODIMENTS

In the following detailed description, for purposes of illustration and not limitation, exemplary embodiments disclosing specific details are set forth in order to provide a thorough understanding of various principles of the disclosure. However, it will be apparent to persons of ordinary skill in the art that the disclosure may be practiced in other embodiments that depart from the specific details disclosed herein, having the benefit of the disclosure.

Unless otherwise stated, the term “between” used in the specification to define a value range is intended to cover a range equal to the stated endpoint values and between the stated endpoint values. For example, a size range between a first value and a second value means that the size range may cover the first value, the second value, and any value between the first value and the second value.

Unless otherwise defined, all terms (including technical and scientific terms) used herein have the same meaning as commonly understood by persons of ordinary skill in the art to which the disclosure belongs.

In the embodiment, the resin composition includes an epoxy resin, an active ester compound, an acrylate resin, an inorganic filler material, and an accelerator. Furthermore, the inorganic filler material includes a first filler and a second filler, wherein a first particle size of the first filler is greater than a second particle size of the second filler, and the second particle size is less than 100 nanometers (nm), so the first filler may be regarded as having a large particle size, and the second filler may be regarded as having a small particle size. In addition, a weight proportion of the second filler in the resin composition is between 1 wt % and 10 wt % (for example, 1 wt %, 3 wt %, 5 wt %, 7 wt %, 10 wt %, or any appropriate value between 1 wt % and 10 wt %). Accordingly, in the embodiment, the filler with the small particle size is introduced to effectively reduce the roughness of subsequent processes (such as after a desmear process). At the same time, through matching the two fillers with different particle sizes with each other, an addition proportion of the filler with the small particle size is controlled to be within an appropriate addition proportion range, so as to maintain the adhesion between the overall inorganic filler material and copper. In this way, the resin composition of the embodiment has preferable performance in terms of both copper-clad adhesion and roughness. Here, the first particle size and/or the second particle size is a median particle size (D₅₀).

For example, since the filler with the small particle size produces smaller pores after the desmear process, the roughness can be effectively improved. At the same time, when the weight proportion of the second filler in the resin composition is greater than 10 wt %, there may easily be an issue of poor adhesion with copper. Therefore, controlling the addition proportion of the filler with the small particle size to be between 1 wt % and 10 wt % can reduce the probability of the issue occurring. In addition, the design of the resin composition of the embodiment can also significantly improve the suspension stability of the filler.

In some embodiments, the second particle size is greater than or equal to 0.01 micrometers, but the disclosure is not limited thereto.

In some embodiments, the first particle size is between 0.1 micrometers and 0.6 micrometers, but the disclosure is not limited thereto.

In some embodiments, the first filler and/or the second filler is prepared by a synthesis method, so that the same contains an epoxy-based or acrylic-based surface modification to improve performance, wherein the synthesis method is, for example, a solid-state synthesis method, etc. that are well known to persons skilled in the art, but the disclosure is not limited thereto.

In some embodiments, a purity of the first filler and/or the second filler is greater than or equal to 99%, but the disclosure is not limited thereto.

In some embodiments, a specific surface area of the first filler and/or the second filler is between 4 m²/g and 10 m²/g to control a contact area with a functional group to be within a preferred range, so that preferred low dielectric properties can be maintained, such as Dk of between 3 and 3.3, and Df of less than or equal to 0.003, but the disclosure is not limited thereto. The specific surface area of the first filler and/or the second filler may be determined according to actual design requirements.

In some embodiments, a weight proportion of the first filler in the resin composition is between 60 wt % and 75 wt %, but the disclosure is not limited thereto.

In some embodiments, a usage amount of the first filler in the resin composition is greater than a usage amount of the second filler in the resin composition, but the disclosure is not limited thereto.

In some embodiments, the inorganic filler material (for example, the first filler and/or the second filler) includes spherical silica, wherein a weight proportion of the inorganic filler material (for example, a sum of weights of the first filler and the second filler) in the resin composition is greater than 60 wt %, but the disclosure is not limited thereto.

In some embodiments, a usage amount of the inorganic filler material in the resin composition is greater than a usage amount of the epoxy resin, the active ester compound, the acrylate resin, and the accelerator in the resin composition, but the disclosure is not limited thereto.

In some embodiments, the epoxy resin includes a naphthalene ring epoxy resin (for example, naphthylene ether type epoxy resin), a bisphenol A type epoxy resin, or a combination thereof, wherein a weight proportion of the epoxy resin in the resin composition is between 5 wt % and 15 wt % (for example, 5 wt %, 7 wt %, 10 wt %, 12 wt %, 15 wt %, or any appropriate value between 5 wt % and 15 wt %), but the disclosure is not limited thereto.

In some embodiments, the active ester compound includes a polyester resin, wherein a weight proportion of the active ester compound in the resin composition is between 10 wt % and 20 wt % (for example, 10 wt %, 12 wt %, 15 wt %, 17 wt %, 20 wt %, or any appropriate value between 10 wt % and 20 wt %), but the disclosure is not limited thereto.

In some embodiments, the acrylate resin includes a methacrylate polyphenylene ether resin, wherein a weight proportion of the acrylate resin in the resin composition is between 1 wt % and 15 wt % (for example, 1 wt %, 3 wt %, 5 wt %, 7 wt %, 15 wt % or any appropriate value between 1 wt % and 15 wt %), but the disclosure is not limited thereto.

In some embodiments, the accelerator includes 4-dimethylaminopyridine, wherein a weight proportion of the accelerator in the resin composition is between 0.1 wt % and 0.5 wt %, but the disclosure is not limited thereto.

In some embodiments, a sum of the weight proportions of the epoxy resin, the active ester compound, the acrylate resin, the inorganic filler material (for example, the first filler and the second filler), and the accelerator in the resin composition is 100 wt %, but the disclosure is not limited thereto.

In some embodiments, a usage amount of the active ester compound in the resin composition is greater than a usage amount of the epoxy resin in the resin composition and/or a usage amount of the acrylate resin in the resin composition is greater than a usage amount of the accelerator in the resin composition, but the disclosure is not limited thereto.

It should be noted that the resin composition may be regarded as a non-volatile component of a resin composition (varnish form) dissolved in a solvent, but the disclosure is not limited thereto. In addition, the resin composition of the disclosure may be processed into a prepreg and a copper clad laminate (CCL) according to actual design requirements, and the specific implementation forms listed above are not limitations of the disclosure.

The following examples and comparative examples are given to illustrate the effects of the disclosure, but the claims of the disclosure are not limited to the scope of the examples.

A product of each example and comparative example was evaluated according to the following method.

Glass transition temperature (Tg) (° C.): the glass transition temperature Tg (° C.) of a material was measured using a thermomechanical analyzer (TMA) according to a standard test method of ASTM E1545.

Coefficient of thermal expansion (CTE) (x-y plane direction): the coefficient of thermal expansion of a X-Y plane, that is, X-Y CTE (ppm/° C.) of the material was measured using a thermomechanical analyzer (TMA) according to a standard test method of IPC-TM-650 2.4.24. A temperature rising range condition of the test was 25° C. to 150° C.

Dielectric constant Dk/dissipation factor Df: a resin film made of a resin composition shown in Table 1 was heated at 200° C. for 90 minutes to form a cured film. The cured film was cut into a size with a length of 10 mm and a width of 7 mm. The dielectric constant (Dk, ϵ r) and the dissipation factor (Df, Tan δ) of the material under a 10 GHz signal were measured according to a standard test method of IPC-TM-650 (Method 2.5.5.3).

Resin sheet material lamination and curing: a glass cloth epoxy resin base material with a copper foil was prepared as an inner substrate, two surfaces were cladded with copper lamination (“NPG-180INBK” manufactured by Nan Ya Plastics Corporation), and the surface copper foil of the inner substrate was roughened. The resin composition and the inner substrate were bonded through a vacuum laminator using the vacuum laminator (“V-130” manufactured by Nikko-Material Co., Ltd.). The conditions were: after reducing the pressure to less than 1 hPa for 30 seconds, pressing was performed for 60 seconds under the conditions of temperature 100° C./pressure 100N. Subsequently, the resin composition was heated in an oven at 130° C. for 30 minutes, and then moved to an oven to be heated at 165° C. for 30 minutes. The resin composition was cured through the heating, and a substrate A was obtained.

Copper-clad adhesion: the evaluation substrate A obtained after the vacuum laminator and heat curing, ⊚: was stably adhered without falling off, X: fell off after baking.

Desmear processing: in order to roughen the cured resin sheet substrate, the substrate A was immersed in Sweller 7810 manufactured by DuPont at 70° C. for 10 minutes. Next, the substrate A was immersed in Promotor 7820 manufactured by DuPont at 85° C. for 10 minutes. Finally, the substrate was immersed in Neutralizer 7831 manufactured by DuPont at 40° C. for 5 minutes, and an evaluation substrate B after the desmear processing was obtained.

Roughness Ra: the evaluation substrate B was measured under a 50× lens using a laser conjugate focus microscope (VK-X3000 manufactured by Keyence Corporation), and 10 points were randomly selected to measure the arithmetic mean roughness Ra, wherein a non-valued part was because the part could not be adhered to copper, so the desmear processing could not be performed to measure the roughness.

Suspension stabilization time: a solvent was added to the resin composition, the same was completely mixed, a formed coating was left to stand, and whether there was obvious delamination/sedimentation was observed with naked eyes and the time was recorded.

### Examples 1 and 2 and Comparative Examples 1 to 4

The resin composition shown in Table 1 was dissolved in a solvent (toluene, butanone, cyclohexanone), the same was applied on a support (PET film) using a die coater, after drying to form a film layer, properties such as the glass transition temperature, the coefficient of thermal expansion, the dielectric constant, the dissipation factor, and the roughness were evaluated, and the copper-clad adhesion and the suspension stability time were tested with the above manners. The results are shown in Table 1. After comparing the results of Examples 1 and 2 and Comparative Examples 1 to 4 in Table 1, the following conclusions may be drawn. Compared with Comparative Examples 1 to 4, Examples 1 and 2 that used a filler with a particle size of less than 100 nanometers and an addition proportion of between 1 wt % and 10 wt % have preferable performance in terms of both copper-clad adhesion and roughness, wherein Comparative Examples 1 to 3 did not use a filler with a particle sizes of less than 100 nanometers, and an addition proportion of Comparative Example 4 was greater than 10 wt %.

TABLE 1

| | Comparative Example | | | | Example | |
|---|---|---|---|---|---|---|
| | 1 | 2 | 3 | 4 | 1 | 2 |
| Epoxy resin (HP6000) (parts by mass) | 6.25 | 6.25 | 6.25 | 6.25 | 6.25 | 6.25 |
| Epoxy resin (NPEL-170) (parts by mass) | 6.25 | 6.25 | 6.25 | 6.25 | 6.25 | 6.25 |
| Active ester compound (HPC-8150) (parts by mass) | 18.85 | 18.85 | 18.85 | 18.85 | 18.85 | 18.85 |
| First filler of inorganic filler material | 100 | 85 | 85 | 85 | 90 | 95 |
| (EQH0610-SES, D50 = 0.6 | | | | | | |
| micrometers, Third Age) (parts by mass) | | | | | | |
| First filler of inorganic filler material (SPF-20M, | 0 | 15 | 10 | 10 | 0 | 0 |
| D50 = 0.2 micrometers, Denka) (parts by mass) | | | | | | |
| First filler of inorganic filler material (SPF-01, | 0 | 0 | 15 | 0 | 0 | 0 |
| D50 = 0.1 micrometers, Tokuyama) (parts by mass) | | | | | | |
| Second filler of inorganic filler | 0 | 10 | 0 | 15 | 10 | 5 |
| material (NANOPOL XP20 1012, | | | | | | |
| D50 = 80 nanometers, Evonik) (parts by mass) | | | | | | |
| Acrylic resin (SA-9000) (parts by mass) | 3.6 | 3.6 | 3.6 | 3.6 | 3.6 | 3.6 |
| Accelerator (DMAP) (parts by mass) | 0.2 | 0.2 | 0.2 | 0.2 | 0.2 | 0.2 |
| Glass transition temperature (° C.) | 173 | 175 | 175 | 176 | 176 | 174 |
| X-Y coefficient of thermal expansion | 15.7 | 13.6 | 13.3 | 13.5 | 14.2 | 14.7 |
| (25° C. to 150° C.) (ppm/° C.) | | | | | | |
| Dk/Df (10 GHz) | 3.2/0.0025 | 3.2/0.004 | 3.4/0.007 | 3.2/0.003 | 3.2/0.0029 | 3.2/0.0028 |
| Copper-clad adhesion | ⊚ | X | X | X | ⊚ | ⊚ |
| Roughness Ra (nm) | 150 | / | / | / | 50 | 50 |
| Suspension stability time (hours) | 12 | 12 | 72 | 72 | 72 | 72 |

In summary, in the disclosure, the filler with the small particle size is introduced to effectively reduce the roughness of subsequent processes. At the same time, through matching the two fillers with different particle sizes with each other, the addition proportion of the filler with the small particle size is controlled to be within the appropriate addition proportion range, so as to maintain the adhesion between the overall inorganic filler material and copper. In this way, the resin composition of the disclosure has preferable performance in terms of both copper-clad adhesion and roughness.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A resin composition, comprising:
an epoxy resin;
an active ester compound;
an acrylate resin;
an inorganic filler material, comprising a first filler and a second filler, wherein the first filler has a first particle size, the second filler has a second particle size, the first particle size is greater than the second particle size, the second particle size is less than 100 nanometers, and a weight proportion of the second filler in the resin composition is between 1 wt % and 10 wt %; and
an accelerator.

2. The resin composition according to claim 1, wherein the second particle size is greater than or equal to 0.01 micrometers.

3. The resin composition according to claim 1, wherein the first particle size is between 0.1 micrometers and 0.6 micrometers.

4. The resin composition according to claim 1, wherein a weight proportion of the first filler in the resin composition is between 60 wt % and 75 wt %.

5. The resin composition according to claim 1, wherein a weight proportion of the epoxy resin in the resin composition is between 5 wt % and 15 wt %, a weight proportion of the active ester compound in the resin composition is between 10 wt % and 20 wt %, a weight proportion of the inorganic filler material in the resin composition is greater than 60 wt %, a weight proportion of the acrylate resin in the resin composition is between 1 wt % and 15 wt %, and a weight proportion of the accelerator in the resin composition is between 0.1 wt % and 0.5 wt %.

6. The resin composition according to claim 1, wherein the epoxy resin comprises a naphthalene ring epoxy resin, a bisphenol A type epoxy resin, or a combination thereof, the active ester compound comprises a polyester resin, the acrylate resin comprises a methacrylate polyphenylene ether resin, the inorganic filler material comprises spherical silica, and the accelerator comprises 4-dimethylaminopyridine.

7. The resin composition according to claim 1, wherein a usage amount of the first filler in the resin composition is greater than a usage amount of the second filler in the resin composition.

8. The resin composition according to claim 1, wherein a usage amount of the inorganic filler material in the resin composition is greater than a usage amount of the epoxy resin, the active ester compound, the acrylate resin, and the accelerator in the resin composition.

9. The resin composition according to claim 1, wherein a usage amount of the active ester compound in the resin composition is greater than a usage amount of the epoxy resin in the resin composition.

10. The resin composition according to claim 1, wherein a usage amount of the acrylate resin in the resin composition is greater than a usage amount of the accelerator in the resin composition.
